(19) United States
(12) Patent Application Publication
(10) Pub. No.: US 2026/0150043 A1
(43) Pub. Date: May 28, 2026

(54) Intelligent BLE Extended Scanning Using Filtering and Hashing

(71) Applicant: Silicon Laboratories Inc., Austin, TX (US)

(72) Inventors: Jitesh Rachamadugu, Hyderabad (IN); Sajid Nurbash, Kamareddy (IN); Srinivasa Reddy Konatham, Guntur (IN); Saikiran Masani, Kamareddy (IN); Ayan Bandhu Ghosh, Kolkata (IN); Harsha Vardhan Yadav Lamba, Hyderabad (IN)

(21) Appl. No.: 18/963,114

(22) Filed: Nov. 27, 2024

(51) Int. Cl. H04W 52/02; H04W 84/18

(52) U.S. Cl. CPC H04W 52/0229; H04W 84/18

(57) ABSTRACT

A device and method that allows the termination of the reception of a previously received Bluetooth advertisement is disclosed. The network device checks several fields within the extended header and compares these to values that it has already received. If they match, the network device terminates receipt of the advertisement and either goes to sleep mode or switches to a different channel to receive another advertisement. The extended header may also include a header checksum so that the network device can validate these values. The header checksum may be a vendor specific implementation using a reserved field in the extended header.

### FIELD

This disclosure describes systems and methods to reduce the power consumption of a wireless network device, and more particularly, a Bluetooth network device during extended and periodic scanning.

### BACKGROUND

Bluetooth is one of many wireless network protocols that are currently in use. Bluetooth is commonly used to connect smartphones to watches, headphones, speakers, and other accessories. Bluetooth low energy utilizes 40 physical channels in the 2.4 GHz ISM band, each channel separated by 2 MHz.

Bluetooth supports advertising, in which the advertiser transmits advertisements on one or more of three primary channels to other devices on the network. These advertisements do not require a previous connection. Bluetooth has upgraded this feature to allow extended advertising, wherein the advertisement on the primary channels is a short packet that contains the time and secondary channel that will be used by the advertiser to send an extended advertisement, which has a larger payload. These extended advertisements are transmitted using protocol data units (PDUs) that are referred to as AUX_ADV_IND PDU packets. There are 37 secondary channels that may be used.

Bluetooth also supports several types of synchronous unidirectional communications. For example, the Bluetooth specification describes a feature known as periodic advertising. In this mode, an advertiser transmits an advertisement at regular intervals on a predetermined channel. The transmission of this advertisement occurs at regular intervals. These regular intervals may be multiples of 1.25 milliseconds, between 7.5 milliseconds and 81.91875 seconds. In this way, a network device is able to enter a low power state and can wake up at predetermined times in order to receive the next advertisement. These periodic advertisements are sent using AUX_SYNC_IND PDU packets.

These extended advertisements and periodic advertisements may be quite long in duration. Further, in some embodiments, the advertiser may transmit the same advertisement multiple times to ensure that all interested devices receive the advertisement. Thus, a network device may wake up to receive an extended advertisement or a periodic advertisement, only to discover that it already received this advertisement. This consumes unnecessary power and also monopolizes the receiver of the network device so that it cannot receive any other advertisements that may be being transmitted on other channels at that time.

Therefore, it would be advantageous if there was a device and method that could allow the network device to quickly and reliably determine whether the extended advertisement or periodic advertisement that is being transmitted has already been received by this network device.

### SUMMARY

A device and method that allows the termination of the reception of a previously received Bluetooth advertisement is disclosed. The network device checks several fields within the extended header and compares these to values that it has already received. If they match, the network device terminates receipt of the advertisement and either goes to sleep mode or switches to a different channel to receive another advertisement. The extended header may also include a header checksum so that the network device can validate these values. The header checksum may be a vendor specific implementation using a reserved field in the extended header.

According to one embodiment, a method of reducing power consumption in a network device, wherein the network device comprises a wireless network interface to receive extended or periodic advertisements from an advertiser, is disclosed. The method comprises receiving, at the network device, an extended header contained in the extended or periodic advertisement; comparing one or more fields in the extended header with values that were already received; and taking an action if the network device determines that the extended or periodic advertisement was already received. In some embodiments, the action comprises disabling the wireless network interface before an entirety of the extended or periodic advertisement is received and entering sleep mode. In some embodiments, the action comprises configuring the wireless network interface to select a different channel before an entirety of the extended or periodic advertisement is received. In some embodiments, the extended header comprises an Extended Header Flags field, and a AdvData Info field, and the network device takes the action following reception of the AdvData Info field. In certain embodiments, the one or more fields in the extended header comprise an Advertising Set ID (SID) and an Advertising Data ID (DID) located in the AdvData Info field. In certain embodiments, the network device saves the SID and DID values of advertisements that were successfully received, and the comparing one or more fields comprises comparing the SID and DID located in the AdvData Info field to previously saved SID and DID values.

According to another embodiment, a method of reducing power consumption in a network device, wherein the network device comprises a wireless network interface to receive extended or periodic advertisements from an advertiser, is disclosed. The method comprises receiving, at the network device, an extended header contained in the extended or periodic advertisement; comparing one or more fields in the extended header with values that were already received; comparing a header checksum contained in the extended header with a computed header checksum; and taking an action if the network device determines that the header checksum is correct and the extended or periodic advertisement was already received. In some embodiments, the action comprises disabling the wireless network interface before an entirety of the extended or periodic advertisement is received and entering sleep mode. In some embodiments, the action comprises configuring the wireless network interface to select a different channel before an entirety of the extended or periodic advertisement is received. In some embodiments, the extended header comprises an Extended Header Flags field, a AdvData Info field, and an Additional Controller Advertising Data (ACAD) field, and wherein the network device takes the action following reception of the ACAD field. In certain embodiments, the one or more fields in the extended header comprise an Advertising Set ID (SID) and an Advertising Data ID (DID) located in the AdvData Info field. In certain embodiments, the network device saves the SID and DID values of advertisements that were successfully received, and the comparing one or more fields comprises comparing the SID and DID located in the AdvData Info field to previously saved SID and DID values. In certain embodiments, the ACAD field contains the header checksum. In certain embodiments, a flag in the Extended Header Flags field is used to indicate that the ACAD field contains the header checksum.

According to another embodiment, a network device is disclosed. The network device comprises a Bluetooth network interface; a processing unit; and a memory device in communication with the processing unit, containing instructions, which when executed by the processing unit, enable the network device to: receive, using the Bluetooth network interface, an extended header contained in the extended or periodic advertisement; compare one or more fields in the extended header with values that were already received; and take an action if the network device determines that the extended or periodic advertisement was already received. In some embodiments, the memory device comprises instructions which when executed by the processing unit, enable the network device to: save the one or more fields in the extended header if the extended or periodic advertisement is successfully received and has not been previously received. In some embodiments, the memory device comprises instructions which when executed by the processing unit, enable the network device to: compute a header checksum based on information located in the extended header; compare the computed header checksum to a header checksum located in the extended header; and take the action only if the network device determines that the extended or periodic advertisement was already received and the computed header checksum matches the header checksum located in the extended header. In some embodiments, the action comprises disabling the Bluetooth network interface before an entirety of the extended or periodic advertisement is received and entering sleep mode. In some embodiments, the action comprises configuring the Bluetooth network interface to select a different channel before an entirety of the extended or periodic advertisement is received.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a representative device that may be utilized according to one embodiment;

FIG. 2 shows the format of a Bluetooth packet;

FIGS. 3A-3B show time lines illustrating Bluetooth extended and periodic advertising, respectively;

FIG. 4 shows the format of a PDU;

FIG. 5 shows the typical payload for an advertisement;

FIG. 6 shows the format of the Extended Header in the advertisement;

FIG. 7 shows a flow chart illustrating one operating mode of the network device; and

FIG. 8 shows a flow chart illustrating a second operating mode of the network device.

### DETAILED DESCRIPTION

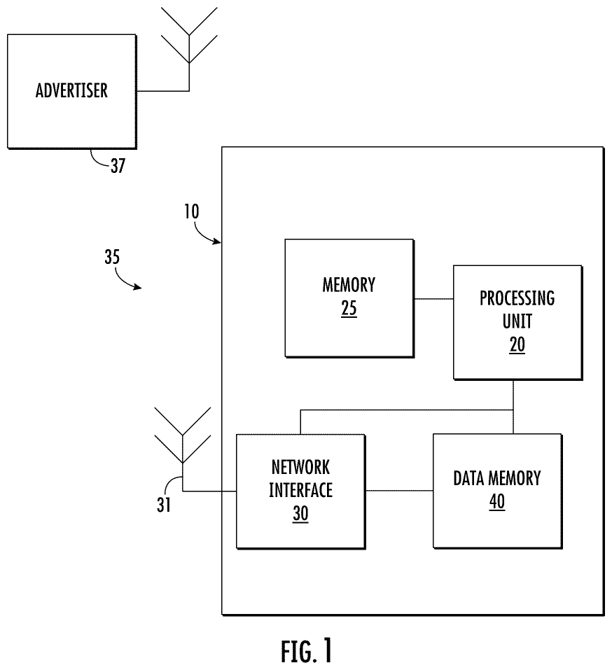

As shown in FIG. 1, the network device 10 has a processing unit 20 and an associated memory device 25. The processing unit 20 may be any suitable component, such as a microprocessor, embedded processor, an application specific circuit, a programmable circuit, a microcontroller, or another similar device. The memory device 25 contains the instructions, which, when executed by the processing unit 20, enable the network device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM. The instructions contained within the memory device 25 may be referred to as a software program, which is disposed on a non-transitory computer readable storage media.

The network device 10 also includes a network interface 30, which may be a wireless network interface that includes an antenna 31. In certain embodiments, the network interface 30 may support any wireless network protocol that supports extended advertisements, such as Bluetooth. The network interface 30 is used to allow the network device 10 to communicate with other devices disposed on the network 35, such as advertiser 37, also referred to as advertiser 1 below.

The network interface 30 is used to process the incoming signal and convert the wireless signals to digital signals.

The network device 10 may include a data memory device 40. Data that is received from the network interface 30 or is to be sent via the network interface 30 may also be stored in the data memory device 40. This data memory device 40 is traditionally a volatile memory.

While a memory device 25 is disclosed, any computer readable non-transitory storage medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1. The second computer readable non-transitory media may be a CDROM, or a different memory device, which is located remote from the network device 10. The instructions contained on this second computer readable non-transitory media may be downloaded onto the memory device 25 to allow execution of the instructions by the network device 10.

While the processing unit 20, the memory device 25, the network interface 30 and the data memory device 40 are shown in FIG. 1 as separate components, it is understood that some or all of these components may be integrated into a single electronic component. Rather, FIG. 1 is used to illustrate the functionality of the network device 10, not its physical configuration.

Although not shown, the network device 10 also has a power supply, which may be a battery or a connection to a permanent power source, such as a wall outlet.

The network device is capable of reducing its power consumption by utilizing a sleep mode. In this sleep mode, some of the components shown in FIG. 1 may be turned off or set to a low power mode. For example, the processing unit 20 may be set to a low power mode or turned off. In addition, the network interface 30 may be put in a low power mode where it cannot receive or transmit data to other devices.

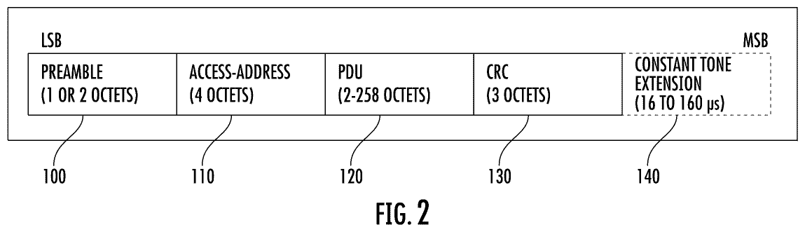

FIG. 2 shows a typical Bluetooth packet. The packet includes a preamble 100, an access-address 110, a protocol data unit (PDU) field 120, a cyclic redundancy code (CRC) 130, and optionally a constant tone extension (CTE) 140. The preamble 100 may have a length of one or two octets, while the access-address 110 may have a length of 4 octets. The PDU field 120 has a variable length, depending on the PDU type and may have a length of between 2 and 258 octets. The CRC 130 has a length of three octets. When included, the CTE 140 may have a length between 16 and 160 μseconds.

As stated above, Bluetooth support several types of advertisements, including periodic advertisements and extended advertisements.

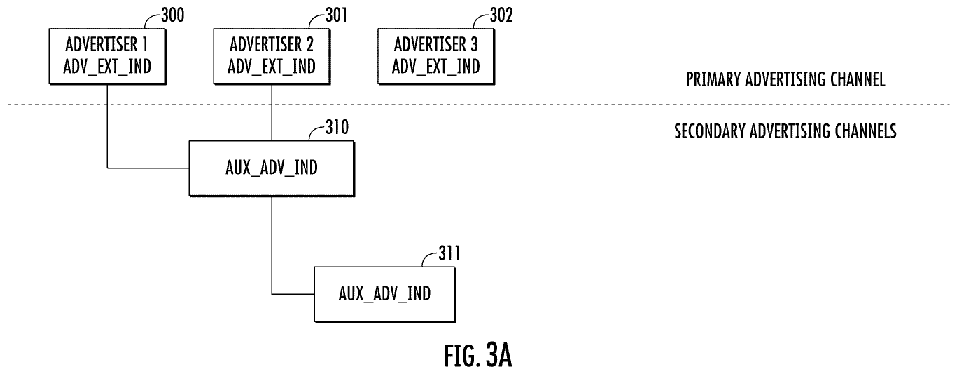

FIG. 3A shows a timing diagram showing the extended advertisement operation used by the Bluetooth protocol. In Bluetooth, three channels are designated as primary advertising channels. The advertiser 37 begins by first transmitting an advertising event 300. This advertising event may be the transmission of a packet on one or more of the primary advertising channels. This packet may be an ADV_EXT_IND PDU packet. The ADV_EXT_IND PDU packet informs the network devices of the channel map, the offset of a subsequent packet (known as the AUX_ADV_IND packet or an extended advertisement) and which PHY is to be used. The advertiser 37 then transmits the extended advertisement (i.e. the AUX_ADV_IND PDU packet 310) on the secondary channel referenced in the ADV_EXT_IND PDU packet. Note that other advertisers, such as advertiser 2 and advertiser 3, may also use the primary channels to transmit advertising events 301, 302, respectively. In some embodiments, another advertising event, such as advertising event 301, may point to another extended advertisement (i.e. AUX_ADV_IND packet 311) on a different secondary channel. Note that there may be times when the advertiser 37 is transmitting the AUX_ADV_IND PDU packet 310 on one secondary channel and the second advertiser may be simultaneously transmitting another AUX_ADV_IND packet 311 on a different secondary channel. Note that the network device 10 cannot receive both of these packets. However, if, on the other hand, the network device 10 was aware that it had already received AUX_ADV_IND PDU packet 310 from advertiser 37, it could switch channels and receive the other AUX_ADV_IND packet 311 being transmitted by advertiser 2 on the different secondary channel.

FIG. 3B shows a timing diagram showing the periodic advertisement operation used by the Bluetooth protocol. The advertiser 37 begins by first transmitting an advertising event 300. This advertising event may be the transmission of a packet on one or more of the primary advertising channels. This packet may be an ADV_EXT_IND PDU packet. As described above, the ADV_EXT_IND PDU packet informs the network devices of the channel map, the offset of a subsequent packet (known as the AUX_ADV_IND packet) and which PHY is being used. The advertiser 37 then transmits the AUX_ADV_IND PDU packet 310 on the secondary channel referenced in the ADV_EXT_IND PDU packet. This packet informs the network device of the offset to the next packet (known as a synchronous periodic advertisement), the fixed interval that will be used between successive advertisements, and the channel map. The advertiser 37 then transmits synchronized periodic advertisements 320, also known as AUX_SYNC_IND PDU packets, on the secondary channel. In some embodiments, an AUX_CHAIN_IND PDU 340 may also be transmitted after a synchronized periodic advertisement 320. Furthermore, the advertiser 37 continues to transmit the synchronized periodic advertisements 320 on the secondary channel at regular intervals (which is defined in the AUX_ADV_IND PDU packet). In operation, the network device 10 wakes up to receive each AUX_SYNC_IND PDU packet, and must remain awake until the entire packet has been received. In other words, the network device 10 exits sleep mode and enables its network interface 30 in advance of each synchronized periodic advertisements 320 and remains in active mode until the entire packet has been received and processed.

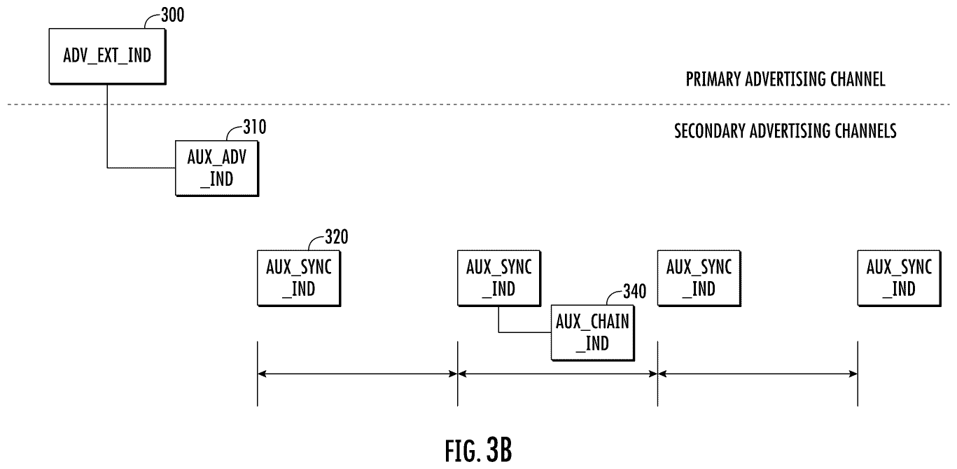

Both the AUX_ADV_IND PDU packet and the AUX_SYNC_IND PDU packet have a similar format. FIG. 4 shows the format of the PDU field 120. Each PDU field 120 has a header 121 and a payload 500.

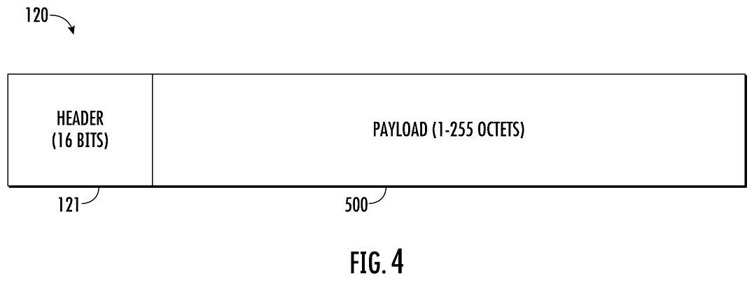

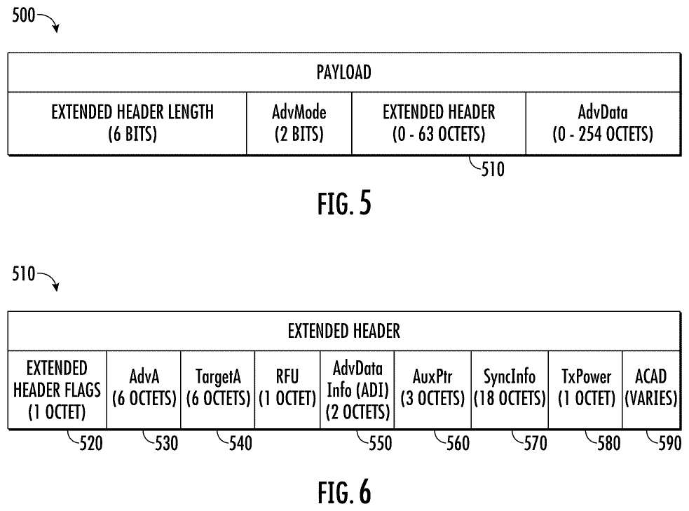

FIG. 5 shows a typical payload 500 for these advertisements. The payload 500 includes an extended header length field, as well as the extended header 510. Other fields may also be included in the payload 500. The extended header 510 may contain a plurality of fields, such as those shown in FIG. 6.

The Extended Header Flags field 520 includes a plurality of bits, where each bit is used to denote whether the corresponding field is included in the extended header 510. For example, there is a bit that corresponds to each of the following fields: AdvA field 530, TargetA field 540, AdvData Info field 550, AuxPtr field 560, SyncInfo field 570, and TxPower field 580. In addition, there is a reserved bit.

The AdvA field 530, when present, contains the advertiser's device address.

The TargetA field 540, when present, contains the address of the target toward which the advertisement is directed.

The AdvData Info field 550, also referred to as ADI, is used to distinguish between different advertising sets. Specifically, the AdvData Info field 550 includes two sub-fields: Advertising Set ID (SID) and Advertising Data ID (DID). The SID is used to differentiate between various advertising sets transmitted by the advertiser, while the DID indicates to the network device if the current data is a duplicate of the previously sent advertising data. Each advertising set is assigned a unique SID. Whenever the advertising data is changed by the advertiser, the DID is updated to a randomly chosen value that is different from the previously used value.

The AuxPtr field 560 indicates that the advertisement is continued in a subsequent auxiliary packet. The AuxPtr field 560 provides the channel, offset and PHY mode used in the auxiliary packet.

The SyncInfo field 570 is used by an AUX_ADV_IND PDU packet 310 to define the parameters associated with the synchronized periodic advertisement 320.

The TxPower field 580 is used to define the power level used by the advertiser 37.

The Additional Controller Advertising Data (ACAD) field 590 is used to communicate metadata, vendor specific information or other descriptive information.

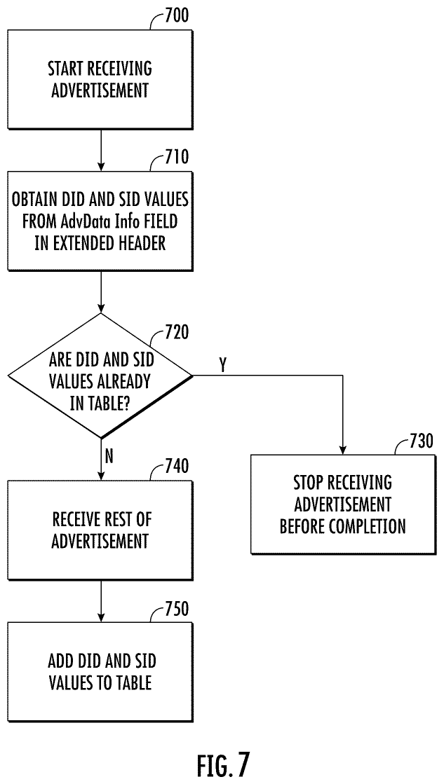

Thus, the AdvData Info field 550 may be used by the network device 10 to determine whether it has already received this particular advertisement. A first embodiment of this method is shown in FIG. 7.

Thus, in this embodiment, the network device 10 creates a table of SID and DID values that have already been received. The network device 10 begins to receive a new advertisement (either a AUX_SYNC_IND PDU or AUX_EXT_IND PDU packet), as shown in Box 700. As shown in Box 710, the network device 10 parses the extended header 510 to obtain the SID and DID values from the AdvData Info field 550. It then compares these SID and DID values to all of those stored in the table, as shown in Decision Box 720. If the values are not present, the network device 10 receives the rest of the advertisement, as shown on Box 740. This is because this is a new advertisement. If the advertisement was successfully received, the network device 10 then adds this new combination of DID and SID values to the table, as shown in Box 750, to indicate that it has received this advertisement. If, on the other hand, the DID and SID values are already present in the table, the network device 10 determines that it has already received this advertisement and aborts receipt of the rest of the packet before it has been completely received, as shown in Box 730. This may happen any time after the DID and SID values have been received. The network device 10 may then take another action. This action may be to allow the network device 10 to return to sleep mode (for example, if it is receiving periodic advertisements). Alternatively, the action may be to switch to a different channel to listen for other extended advertisements.

This approach assumes that there are no transmission errors in the DID and SID values. However, note that the CRC 130 for the packet is not transmitted until the end of the payload (see FIG. 2). Thus, in the embodiment shown in FIG. 7, it is possible that there was a transmission error in the AdvData Info field 550. Thus, in order to verify that the AdvData Info field 550 is indeed correct and does not contain any transmission errors, it may be necessary for the network device 10 to receive the entire packet.

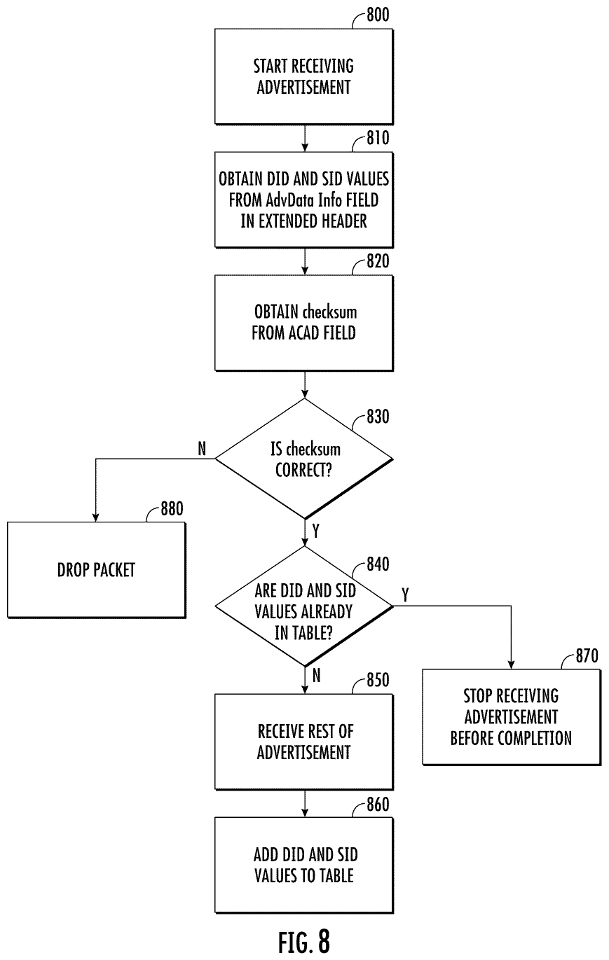

However, a new mechanism is disclosed herein to eliminate the need to receive the entire advertisement. In this embodiment, the ACAD field 590 is used as a header checksum for the extended header 510. In other words, the ACAD field 590 is used to check the accuracy of the DID and SID values. This header checksum may be a hash, a CRC or another other value that allows for verification of the integrity of the DID and SID values. In some embodiments, all of the data in the extended header (except the ACAD field 590) to compute the header checksum. In other embodiments, only a portion of the extended header, which includes the AdvData Info field 550, is used to compute the header checksum. This embodiment is shown in FIG. 8.

The network device 10 begins to receive a new advertisement (either a AUX_SYNC_IND PDU or AUX_EXT_IND PDU packet), as shown in Box 800. As shown in Box 810, the network device 10 parses the extended header 510 to obtain the SID and DID values from the AdvData Info field 550. The network device 10 then obtains the header checksum from the ACAD field 590, as shown in Box 820. The network device 10 then compares the received header checksum to the computed value, as shown in Decision Box 830. In one embodiment, the network device calculates the checksum from the received extended header 510 and compares it to the received header checksum. If the checksums match, the network device 10 then compares the SID and DID values to all of those stored in the table, as shown in Decision Box 840. If the values are not present, the network device 10 receives the rest of the advertisement, as shown on Box 850. If the advertisement is successfully received, the network device 10 then adds this new combination of DID and SID value to the table, as shown in Box 860, to indicate that it has now received this advertisement. Returning to Decision Box 840, if the values are already present, the network device 10 determines that it has already received this advertisement and aborts receipt of the rest of the packet before it has been completely received, as shown in Box 870. This may occur any time after the receipt of the ACAD field 590. The network device 10 may then take another action. This action may be to allow the network device 10 to return to sleep mode (for example, if it is receiving periodic advertisements). Alternatively, the action may be to switch to a different channel to listen for other extended advertisements.

Returning to Decision Box 830, if the checksums do not match, the network device 10 may stop receiving the packet, as shown in Box 880. In another embodiment, the network device 10 may elect to receive the entire packet and determine if the CRC 130 at the end of the packet can be used to correct the transmission error.

Note that the method of FIG. 8 is only effective if both the advertiser 37 and the network device 10 are operating in this enhanced mode wherein the ACAD field 590 is used as the header checksum. Thus, the advertiser 37 needs to inform the network device 10 that this advertisement is being transmitted using this enhanced mode. In one embodiment, this information may be transmitted in the advertisement itself. As noted above, the Extended Header Flags field 520 includes a reserved bit. In some embodiments, an advertiser 37 may set this reserved bit to 1 to indicate that the ACAD field 590 contains the header checksum. If this reserved bit is set to 0, then the network device 10 knows that this enhanced mode is not being used for this advertisement.

Thus, in certain embodiments, the sequence shown in FIG. 8 includes an additional check. Before the checksum is compared in Decision Box 830, the network device 10 first checks if this advertisement is being transmitted in enhanced mode. If it is, the network device executes the rest of the sequence in FIG. 8. If, however, the advertisement is not transmitted in enhanced mode, the network device 10 may operate in one of two modes. In one mode, it executes the sequence shown in FIG. 7, assuming that there is no transmission error in the DID and SID values. In the other mode, the network device 10 disables this optimization, such that the advertisement is always received in its entirety.

In summary, in certain embodiments, the network device 10 may enable the network interface 30 to allow at least the extended header 510 to be received. Depending on the values of the DID and SID fields, and optionally the header checksum, the network device 10 may then stop reception of the advertisement after receipt of the Extended Header 510, but before the completion of the advertisement. This minimizes the time required to process a duplicate advertisement, allowing the network device to take another action, such as returning to sleep mode or listening on other channels for additional advertisements.

While FIGS. 7-8 show the SID and DID values are being saved and compared, other embodiments are also possible. For example, in certain embodiments, a value indicative of the SID and DID values may be utilized. For example, the header checksum, which is computed based on the SID and DID values, may be saved by the network device 10 (in Boxes 750 and 860) and also used for comparison in Decision Boxes 720 and 840.

The present system and method has many advantages. For periodic advertisements, there may be a large power savings. A periodic advertisement may be hundreds of microseconds in length. By being able to detect that this is a duplicate advertisement after receipt of the extended header can reduce the amount of time that the network device remains in receive mode. This allows the network device to spend more time in sleep mode. For extended advertisements, the ability to detect duplicate advertisements allows the network device to switch to a different channel to attempt to receive an advertisement from another advertiser if desired.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of reducing power consumption in a network device, the network device comprising a wireless network interface to receive extended or periodic advertisements from an advertiser, the method comprising:
receiving, at the network device, an extended header contained in the extended or periodic advertisement;
comparing one or more fields in the extended header with values that were already received; and
taking an action if the network device determines that the extended or periodic advertisement was already received.

2. The method of claim 1, wherein the action comprises disabling the wireless network interface before an entirety of the extended or periodic advertisement is received and entering sleep mode.

3. The method of claim 1, wherein the action comprises configuring the wireless network interface to select a different channel before an entirety of the extended or periodic advertisement is received.

4. The method of claim 1, wherein the extended header comprises an Extended Header Flags field, and a AdvData Info field, and wherein the network device takes the action following reception of the AdvData Info field.

5. The method of claim 4, wherein the one or more fields in the extended header comprise an Advertising Set ID (SID) and an Advertising Data ID (DID) located in the AdvData Info field.

6. The method of claim 5, wherein the network device saves the SID and DID values of advertisements that were successfully received, and the comparing one or more fields comprises comparing the SID and DID located in the AdvData Info field to previously saved SID and DID values.

7. A method of reducing power consumption in a network device, the network device comprising a wireless network interface to receive extended or periodic advertisements from an advertiser, the method comprising:
receiving, at the network device, an extended header contained in the extended or periodic advertisement;
comparing one or more fields in the extended header with values that were already received;
comparing a header checksum contained in the extended header with a computed header checksum; and
taking an action if the network device determines that the header checksum is correct and the extended or periodic advertisement was already received.

8. The method of claim 7, wherein the action comprises disabling the wireless network interface before an entirety of the extended or periodic advertisement is received and entering sleep mode.

9. The method of claim 7, wherein the action comprises configuring the wireless network interface to select a different channel before an entirety of the extended or periodic advertisement is received.

10. The method of claim 7, wherein the extended header comprises an Extended Header Flags field, a AdvData Info field, and an Additional Controller Advertising Data (ACAD) field, and wherein the network device takes the action following reception of the ACAD field.

11. The method of claim 10, wherein the one or more fields in the extended header comprise an Advertising Set ID (SID) and an Advertising Data ID (DID) located in the AdvData Info field.

12. The method of claim 11, wherein the network device saves the SID and DID values of advertisements that were successfully received, and the comparing one or more fields comprises comparing the SID and DID located in the AdvData Info field to previously saved SID and DID values.

13. The method of claim 10, wherein the ACAD field contains the header checksum.

14. The method of claim 13, wherein a flag in the Extended Header Flags field is used to indicate that the ACAD field contains the header checksum.

15. A network device, comprising:
a Bluetooth network interface;
a processing unit; and
a memory device in communication with the processing unit, containing instructions, which when executed by the processing unit, enable the network device to:
receive, using the Bluetooth network interface, an extended header contained in the extended or periodic advertisement;
compare one or more fields in the extended header with values that were already received; and
take an action if the network device determines that the extended or periodic advertisement was already received.

16. The network device of claim 15, wherein the memory device comprises instructions which when executed by the processing unit, enable the network device to:
save the one or more fields in the extended header if the extended or periodic advertisement is successfully received and has not been previously received.

17. The network device of claim 15, wherein the memory device comprises instructions which when executed by the processing unit, enable the network device to:
compute a header checksum based on information located in the extended header;
compare the computed header checksum to a header checksum located in the extended header; and
take the action only if the network device determines that the extended or periodic advertisement was already received and the computed header checksum matches the header checksum located in the extended header.

18. The network device of claim 15, wherein the action comprises disabling the Bluetooth network interface before an entirety of the extended or periodic advertisement is received and entering sleep mode.

19. The network device of claim 15, wherein the action comprises configuring the Bluetooth network interface to select a different channel before an entirety of the extended or periodic advertisement is received.
